(19) United States
(12) Patent Application Publication
(10) Pub. No.: US 2009/0052454 A1
(43) Pub. Date: Feb. 26, 2009

(54) METHODS, SYSTEMS, AND COMPUTER READABLE MEDIA FOR COLLECTING DATA FROM NETWORK TRAFFIC TRAVERSING HIGH SPEED INTERNET PROTOCOL (IP) COMMUNICATION LINKS

(76) Inventors: Jean-Francois Pourcher, Mennecy (FR); William Salvin, Spechbach le Bas (FR); Dominique Becq, Brunstatt (FR); Christophe Stoeckel, Lachapelle-Sous-Rougemont (FR)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/185,672

(22) Filed: Aug. 4, 2008

Related U.S. Application Data
(60) Provisional application No. 60/963,195, filed on Aug. 2, 2007.

(51) Int. Cl. H04L 12/56

(52) U.S. Cl. 370/392

(57) ABSTRACT

Methods, systems, and computer readable media for collecting data from network traffic traversing a high speed Internet protocol communication links are disclosed. According to one method, a plurality of packet classification filters is cascaded to form n stages of the packet classification filters connected to series, where n is an integer of at least two. At the nth stage, network traffic copied from a high speed IP communication link is received and first packet classification processing is performed to identify an attribute of each packet of the network traffic. If the attribute is identifiable at the nth stage and is of interest for a first type of data collection processing, the first type of data collection processing is performed for the packet. If the attribute is not identifiable at the nth stage, the packet is forwarded to at least one additional stage of the n stages for second packet classification processing that is different from the first packet classification processing to identify the attribute.

### RELATED APPLICATIONS

This application claims the benefit of U.S. Provisional Patent Application Ser. No. 60/963,195, filed Aug. 2, 2007; the disclosure of which is incorporated herein by reference in its entirety.

### TECHNICAL FIELD

The subject matter described herein relates to methods and systems for monitoring various packet types of Internet Protocol (IP) traffic that traverse a communications network. More particularly, the subject matter described herein relates to methods, systems, and computer readable media for collecting data from network traffic traversing high speed Internet protocol (IP) communication links.

### BACKGROUND

In computer network environments, such as network environments that carry telecommunications traffic, it may be desirable to collect data regarding traffic that traverses a network or a communication link within a network. For example, data collection devices often use taps on communication links to copy packets that traverse the communication links. The copied packets are forwarded to an application for processing. In a telecommunications network, one type of processing performed for copied packets is telecommunications detail record (xDR) generation, which includes correlating signaling message packets relating to common transactions and generating records from the packets. Examples of xDRs that are commonly generated include call detail records (CDRs) and transaction detail records (TDRs).

Another type of processing that it may be desirable to perform on packets traversing a telecommunications network is the computation of call quality metrics, such as the mean opinion score (MOS) for a call. Calculating call quality metrics, such as the MOS, can involve analyzing media packets for the call.

In prior and in some existing communications networks, communication links are of relatively low speed and are dedicated to carrying the same type of traffic. For example, in SS7 signaling networks, some SS7 signaling links are TDM based and have link bandwidths or transmission speeds of 64 kilobits per second. Bearer channel data is sent over separate trunks. Accordingly, it is relatively easy to copy the signaling messages from the signaling links and perform data collection processing, such as xDR processing at the relatively low line rates.

More modern telecommunications and other types of networks carry multi-protocol traffic over the same communication links. For example, an Internet protocol communication link in a telecommunications signaling network that uses voice over IP may carry signaling message traffic, bearer channel traffic, and non-telecommunications traffic, such as hypertext transfer protocol (HTTP) traffic, file transfer protocol (FTP) traffic, simple mail transfer protocol (SMTP) traffic, etc. In addition to the different types of non-telecommunications signaling traffic, different types of telecommunications signaling traffic may be carried. Examples, of such traffic include real time transport control protocol (RTCP) traffic, session initiation protocol (SIP) traffic, H.323 traffic, SS7/IP traffic, etc. Bearer channel data can likewise be carried in different types of protocols. For example, real time transport protocol (RTP) can be used to carry telecommunications bearer channel traffic.

In light of the number of different types of protocol traffic that may traverse a communication link, network data collection is becoming increasingly complex. For example, applications that filter or analyze the traffic must be capable of identifying the protocol type of multiple different types of messages. The increase in complexity of the filtering or packet classification algorithms increases the processing time of each packet. In addition to the increase in processing required for mixed protocol traffic, the line rates of IP communication links are increasing. Because line rates and the packet processing complexity are increasing, network data collection applications may be incapable of classifying packets and/or collecting data from the network traffic at line rates. In addition, it may be desirable to identify packets that require different amounts of processing so that he packets can be segregated and sent to a processor that provides the appropriate amount processing for a given packet.

Accordingly, in light of these difficulties, there exists a need for more efficient methods, systems, and computer readable media for collecting data from network traffic traversing high speed Internet protocol (IP) communication links.

### SUMMARY

Methods, systems, and computer readable media for collecting data from network traffic traversing a high speed Internet protocol communication links are disclosed. According to one method, a plurality of packet classification filters is cascaded to form n stages of the packet classification filters connected to series, where n is an integer of at least two. At the nth stage, network traffic copied from a high speed IP communication link is received and first packet classification processing is performed to identify an attribute of each packet of the network traffic. If the attribute is identifiable at the nth stage and is of interest for a first type of data collection processing, the first type of data collection processing is performed for the packet. If the attribute is not identifiable at the nth stage, the packet is forwarded to at least one additional stage of the n stages for second packet classification processing that is different from the first packet classification processing to identify the attribute.

According to another aspect of the subject matter described herein, a system for collecting data for network traffic traversing a high speed IP communication link is provided. The system includes at least one signaling link tap for copying network traffic from a high speed Internet protocol communication link. The system further includes a plurality of cascaded packet classification filters forming n stages of the packet classification filters connected in series, n being an integer of at least two. At least some of the stages include packet data collection modules for performing different types of packet data collection operations. The packet classification filter at the nth stage receives network traffic copied form a high speed IP communication link and performs first packet classification processing to identify an attribute of each packet of the mixed protocol traffic. If the attribute is identifiable at the nth stage and is of interest for a first type of data collection processing, a first packet data collection module performs the first type of data collection processing for the packet. If the attribute is not identifiable at the nth stage, the packet classification filter at the nth stage forwards the packet to at least one additional stage of the n stages for second packet classification processing that is different from the first packet classification processing to identify the attribute.

The subject matter described herein for collecting data from network traffic traversing high speed IP communication links may be implemented using a computer readable medium having stored thereon computer executable instructions that when executed by the processor of a computer perform steps. Exemplary computer readable media suitable for implementing the subject matter described herein include chip memory devices, disk memory devices, programmable logic devices, and application specific integrated circuits. In addition, a computer program product that implements the subject matter described herein may be located on a single device or computing platform or may be distributed across multiple devices or computing platforms.

### BRIEF DESCRIPTION OF THE DRAWINGS

Preferred embodiments of the subject matter described herein will now be explained with reference to the accompanying drawings of which:

FIG. 1 is a block diagram of an exemplary network utilizing taps to copy packets for network data collection according to an embodiment of the subject matter described herein;

FIG. 2 is a block diagram of an exemplary system for collecting data from network traffic traversing a high speed IP communications link according to an embodiment of the subject matter described herein;

FIG. 3 is a flow chart illustrating an exemplary process for collecting data from network traffic traversing a high speed IP communications link according to an embodiment of the subject matter described herein;

FIG. 4 illustrates exemplary parameters in a RTCP packet that can be used for prefiltering RTCP traffic according to an embodiment of the subject matter described herein;

FIG. 5 illustrates an RTCP packet, an RTCP filter mask, and an RTCP filter value that may be implemented by a preprocessing module in identifying RTCP packets according to an embodiment of the subject matter described herein;

FIG. 6 is a diagram illustrating an exemplary Ethernet frame, an RTP filter mask, an RTP filter value, and a filter action that may be implemented by a preprocessing module to identify and discard RTP packets according to an embodiment of the subject matter described herein;

FIG. 7 is a block diagram of the system illustrated in FIG. 2 illustrating exemplary collection of HTTP data from network traffic traversing a high speed IP communications link according to an embodiment of the subject matter described herein;

FIG. 8 is a block diagram of a portion of the system illustrated in FIG. 2 illustrating the implementation of hardware counters per filtered session according to an embodiment of the subject matter described herein;

FIG. 9 is a block diagram of the system illustrated in FIG. 2 illustrating exemplary data collection from FTP traffic collected from network traffic traversing a high speed IP communication link according to an embodiment of the subject matter described herein; and

FIG. 10 is a block diagram of the system illustrated in FIG. 2 depicting the collection of data from RTCP and RTP traffic copied from network traffic traversing a high speed IP communications link according to an embodiment of the subject matter described herein.

### DETAILED DESCRIPTION

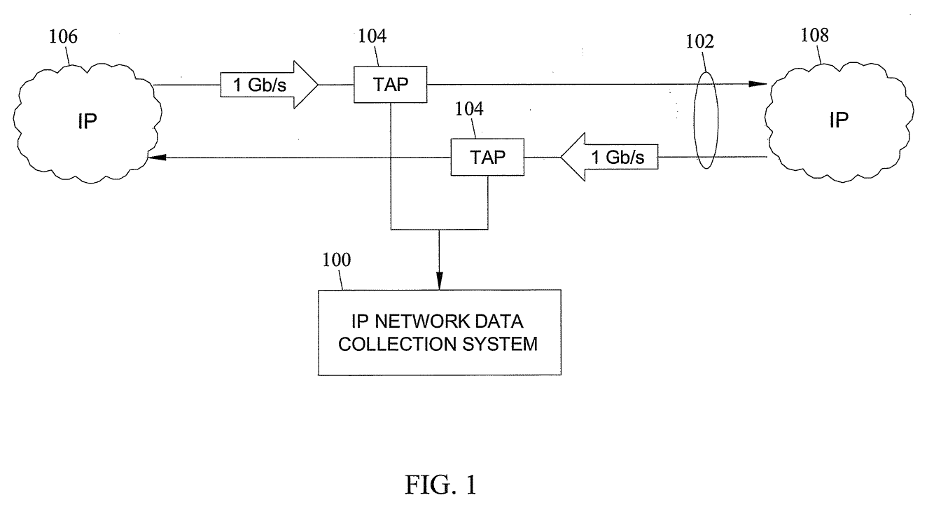

Methods, systems, and computer readable media for collecting data from network traffic traversing high speed IP communication links are disclosed. FIG. 1 is a block diagram illustrating an exemplary IP network data collection system connected to an IP communications link according to an embodiment of the subject matter described herein. Referring to FIG. 1, data collection system 100 may copy the signaling message traffic from both directions of an IP signaling link 102 using taps 104. Signaling link 102 may carry data packets of the same protocol types or of different protocol types transmitted between IP networks 106 and 108. Examples of protocol types that may be carried include RTP, RTCP, FTP, HTTP, MGCP, SIP, H.323, SS7/IP, etc. In addition, in the illustrated example, IP communication link 102 is a high speed IP communication link, which in current network architectures may have a line rate on the order of one gigabyte per second. However, the subject matter described herein is not limited to processing packets copied from a signaling link with a rate of one gigabyte per second. The hierarchical processing methods described herein are capable of efficiently processing traffic at higher or lower line rates than those illustrated in FIG. 1.

Rather than applying the same type of processing to all packets, IP network data collection system 100 may apply prefiltering to identify packet attributes, such as protocol types or application data, and may distribute packets to different types of data collection modules that perform different types of data collection processing and consume different amounts of processing bandwidth.

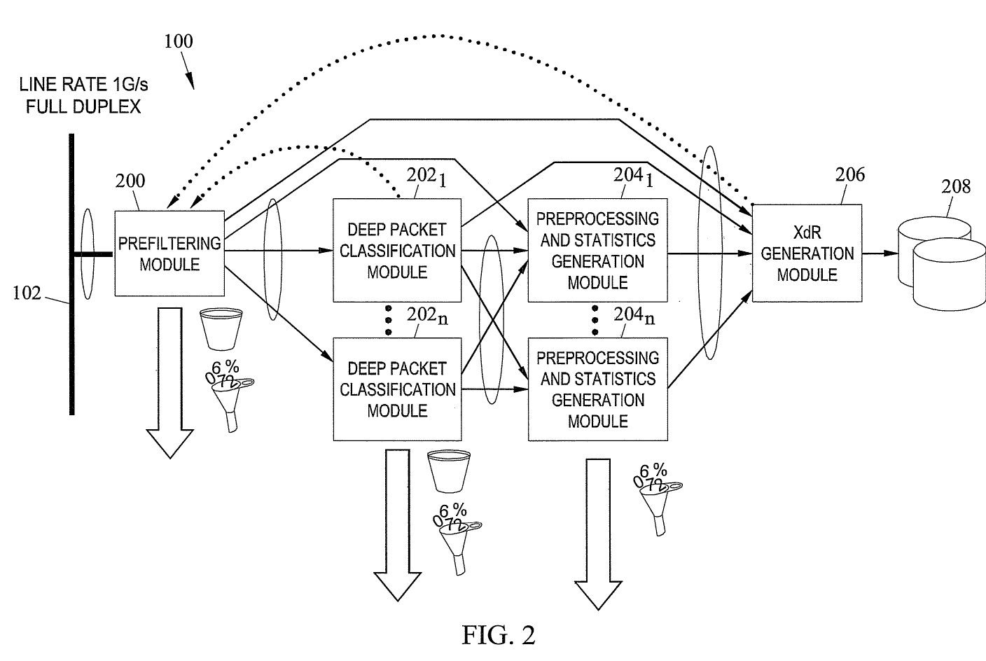

FIG. 2 is a block diagram illustrating exemplary details of system 100 according to an embodiment of the subject matter described herein. Referring to FIG. 2, IP network data collection system 100 includes a prefiltering module 200, a plurality of different levels of data collection modules 202, 204, and 206, at least some of which include storage 208. Prefiltering module 200 may prefilter copied network traffic to identify a protocol type of the traffic and may distribute the traffic to one of modules 202, 204, and 206 based on the identified protocol type. In one embodiment, prefiltering module 200 may be implemented in hardware and may utilize bitmap-based comparisons to classify packets. Examples of such comparisons will be described in detail below. In one implementation, the packet classification algorithms implemented by prefiltering module 200 may identify substantially all, but less than all of the protocol types of the traffic copied from link 102. For example, prefiltering module 200 may identify about 95% of the protocol types of the traffic copied from link 102.

For traffic for which the protocol type or other attribute cannot be identified, prefiltering module 200 may forward such traffic to one of deep packet classification modules 202₁-202ₙ. Deep packet classification modules 202₁-202ₙ may perform deep packet classification, i.e., processor intensive analysis of header information contained in various levels of the packet to identify the protocol type or other attribute. Once deep packet classification modules 202₁-202ₙ identify the protocol type or other attribute, the packets may be forwarded to a data collection module according to the identified protocol type. Alternatively, if the attribute is identified and is not of interest for data collection processing, packets having the attribute may be discarded.

In the example illustrated in FIG. 2, each combination of prefiltering module 200 and one of modules 202₁-202ₙ forms two stages of packet classification filters. At each stage, a packet classification filter implemented by module 200 or one of modules 202₁-202ₙ may determine whether a packet attribute is identifiable and of interest for data collection processing. If the attribute is identifiable and of interest for data collection processing, the data collection processing may be performed by the packet classification filter or by a data collection module associated with the desired type of data collection processing. If the attribute is identifiable and not of interest for data collection processing, the packet may be discarded. If the attribute is not identifiable at a particular stage, as stated above, the packet may be forwarded to at least one additional stage for further packet classification processing.

Although in the example illustrated in FIG. 2, each combination pf prefiltering module 200 with of deep packet classification modules 2021-202n forms a two stage packet classification filter, the subject matter described herein is not limited to two stages of packet classification filters. Any number of packet classification filters may be cascaded to form m packet classification filters connected in series, where m is an integer of at least two.

As indicated above, one packet attribute that it may be desirable to identify is the protocol type. For example, it may be desirable to identify and separate RTP traffic from signaling traffic in a telecommunications network. Another packet attribute that it may be desirable to identify is application data, including URLs or search keywords for Internet search engine traffic. For example, a first packet classification filter at a first stage may identify and forward HTTP traffic to a packet classification filter at a subsequent stage to identify HTTP traffic originating from a particular search engine, such as GOOGLE®, or containing particular search keywords. The ability to divide packet classification for such processing into plural stages where later stages require deeper packet inspection increases the volume of traffic that can be processed by a packet data collection system in a given time period over single stage approaches. For example, if a single packet classification filter were required to identify HTTP traffic that contains GOOGLE® search queries containing particular search keywords, the packet classification filter would be complex, as it would require inspection of multiple layers of a packet, and the packet classification filter would likely cause the processor on which it is implemented to become overwhelmed.

Certain types of traffic for which prefiltering module 200 identifies the protocol type or other attribute may require different types of data collection processing. For example, it may be desirable to generate xDRs based on telecommunications signaling message traffic. Accordingly, prefiltering module 200 may forward such traffic to xDR generation module 206 to generate xDRs based on the telecommunication signaling messages. As described above, examples of xDRs that may be generated by xDR generation module 206 include call detail records (CDRs), transaction detail records (TDRs), or any other type of record that includes signaling messages or signaling message parameters. Generation of xDRs may include correlating messages that are related to the same transaction or session. Accordingly, once xDR generation module 206 identifies a message as the first message to be included in an xDR, xDR generation module 206 may forward a filter update to prefiltering module 200 to forward packets that are part of the same session as the first received packet for a session directly to xDR generation module 206 in a manner that bypasses deep packet classification modules 202₁-202ₙ and preprocessing and statistics generation modules 204₁-204ₙ.

Preprocessing and statistics generation modules 204₁-204ₙ may generate statistics for different types of traffic. For example, some statistical calculations require the treatment of a high volume of information for a minimum amount of relevant information. One example of such a computation is the computation of a quality metric for a telecommunications call, such as the MOS. The MOS is a quality metric that may be computed by preprocessing and statistics generation modules 204₁-204ₙ every x seconds based on RTP packet analysis. Another example of statistics generation that may be performed by preprocessing and statistics generation modules 204₁-204ₙ is the counting of packets of different protocol types. For example, preprocessing and statistics generation modules 204₁-204ₙ may identify the percentage of voice over IP traffic, HTTP traffic, and FTP traffic traversing signaling links 102.

In another example, to avoid unnecessary downstream processing, prefiltering module 200 may truncate at least some of the packets that it receives. For example, certain types of statistics generated by preprocessing and statistics generation modules 204₁-204ₙ may only require analysis of the packet headers. Accordingly, prefiltering module 200 may truncate the packets by removing the packet payloads and forwarding the headers to modules 204₁-204ₙ.

At each stage in system 100, packets may be discarded to avoid unnecessary processing. The discarding of packets is indicated by the downward pointing arrows in FIG. 2. In addition, at each stage, packets may be counted at the prefiltering stage or at modules 202 or 204. The counting is indicated by the presence of funnels and baskets at each stage in FIG. 2.

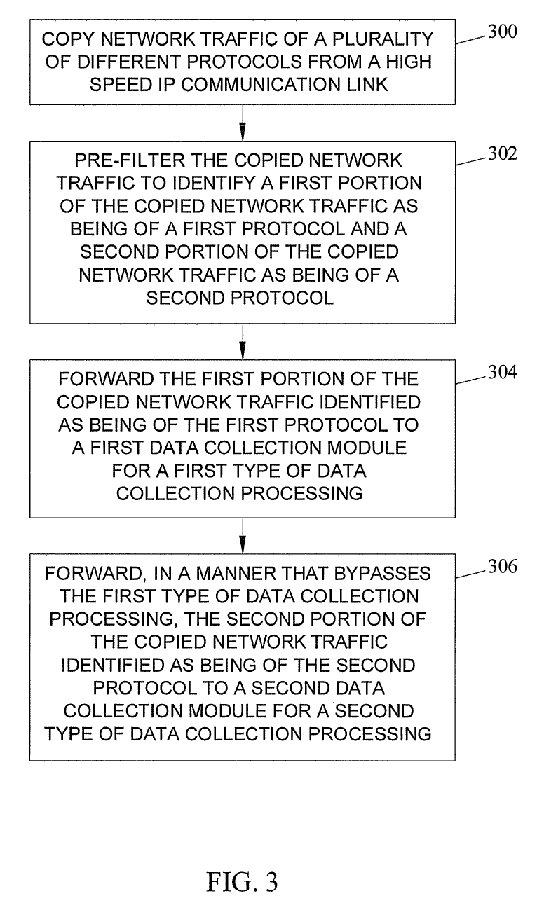

FIG. 3 is a flow chart illustrating an exemplary process for collecting data from network traffic traversing high speed Internet protocol communication link. Referring to FIG. 3, in step 300, network traffic of a plurality of different protocols is copied from a high speed IP communication link. For example, referring to FIG. 1, traffic of multiple protocols, such as RTP, RTCP, FTP, HTTP, etc. may be copied from signaling link 102 using taps 104.

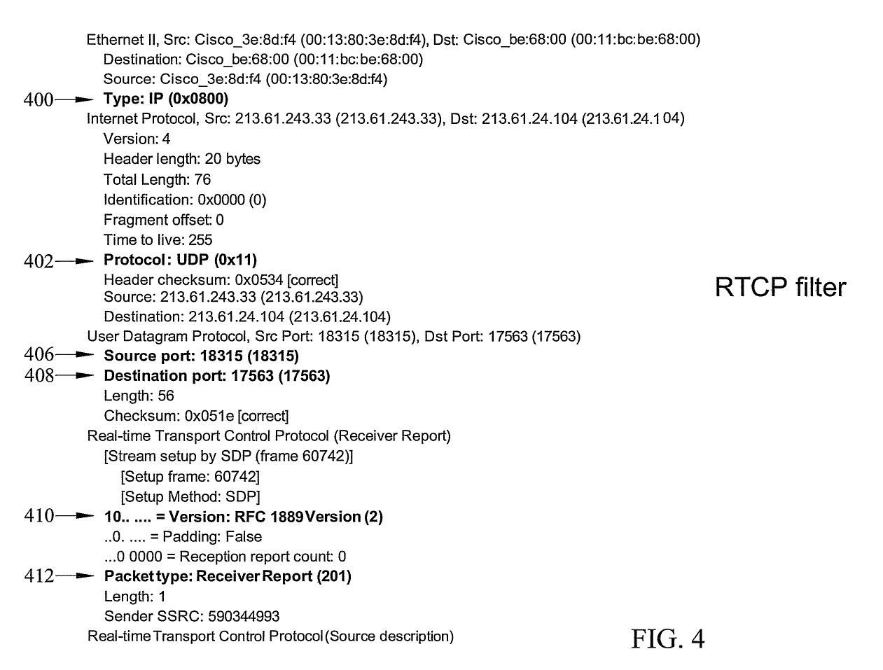

Returning to FIG. 3, in step 302, the copied network traffic may be prefiltered to identify a first portion of the copied network traffic as being of a first protocol and a second portion of the copied network traffic as being of a second protocol. Referring to FIG. 2, prefiltering module 200 may apply one or more filters to identify the protocols of copied signaling messages. FIGS. 4-6 illustrate examples of filters that may be applied by prefiltering module 200. Referring to FIG. 4, exemplary parameters of an RTCP packet are illustrated. Parameters that may be used as part of an RTCP filter are indicated in bold and labeled by reference numbers 400, 402, 406, 408, 410, and 412. For example, parameter 400 is the Ethernet frame type, which for RTCP is IP and is indicated by hexadecimal value OX0800. Similarly, the transport layer protocol type parameter 402 for RTCP is UDP, indicated by the hexadecimal value OX11. The source and destination ports for RTCP are indicated by the values in parameters 406 and 408. Finally, the RTCP version parameter 410 and packet type parameter 412 may be used by prefiltering module 200 to identify and RTCP packet.

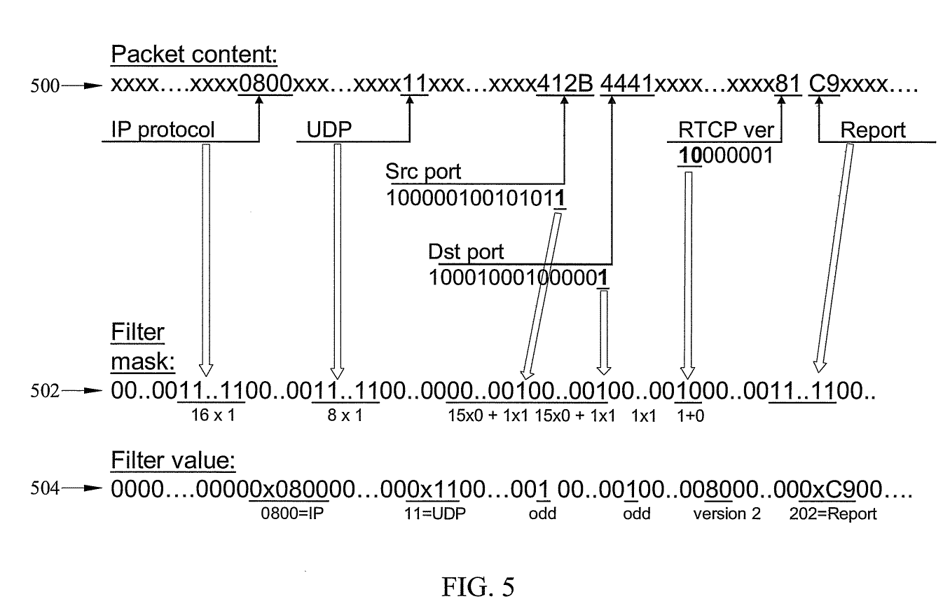

FIG. 5 illustrates an exemplary packet 500, an RTCP filter mask 502, and a filter value 504 that may be compared to packet 500 after applying mask 502. Filter mask 502 may be implemented by packet prefiltering module 200 illustrated in FIG. 2. When filter mask 502 is applied to the corresponding bits of packet 500, the result is compared to filter value 504 to determine whether the packet is an RTCP packet. If the masked packet matches filter value 504 the packet may be identified as an RTCP packet.

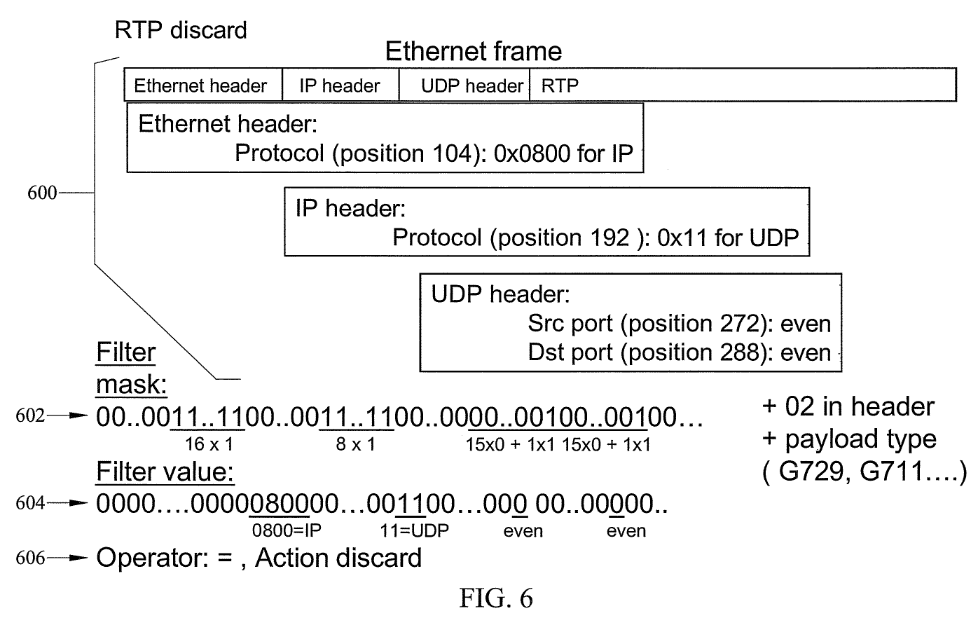

FIG. 6 illustrates another example of a filter that may be implemented by prefiltering module 200 to identify RTP packets. In particular, FIG. 6 illustrates an Ethernet frame 600 including values that would identify a packet as RTP. A corresponding filter mask 602 may be implemented by prefiltering module 200 for application to incoming packets. Filter value 604 may be the corresponding value that is compared to an incoming packet after application of filter mask 602. In addition, a filter that is implemented by prefiltering module 200 may include an action, which in this case is “discard.” RTP packets may be discarded, for example, when it is desirable only to count the RTP packets and avoid forwarding the packets to downstream processing modules.

Returning to FIG. 3, in step 304, a first portion of the network traffic identified as being of the first protocol is forwarded to a first data collection module for a first type of data collection processing. In step 306, the second portion of the copied network traffic identified as being of the second protocol is forwarded to a second data collection module for a second type of data collection processing. In one implementation, the first and second types of data collection processing require different amounts of processing bandwidth. In a general example, referring to FIG. 2, some packets may be forwarded to preprocessing and statistics generation modules 204 for preprocessing and/or statistics generation while other packets may be forwarded to xDR generation module 206 for xDR generation. The amount of processing required to generate xDRs may be different from that required to generate packet statistics.

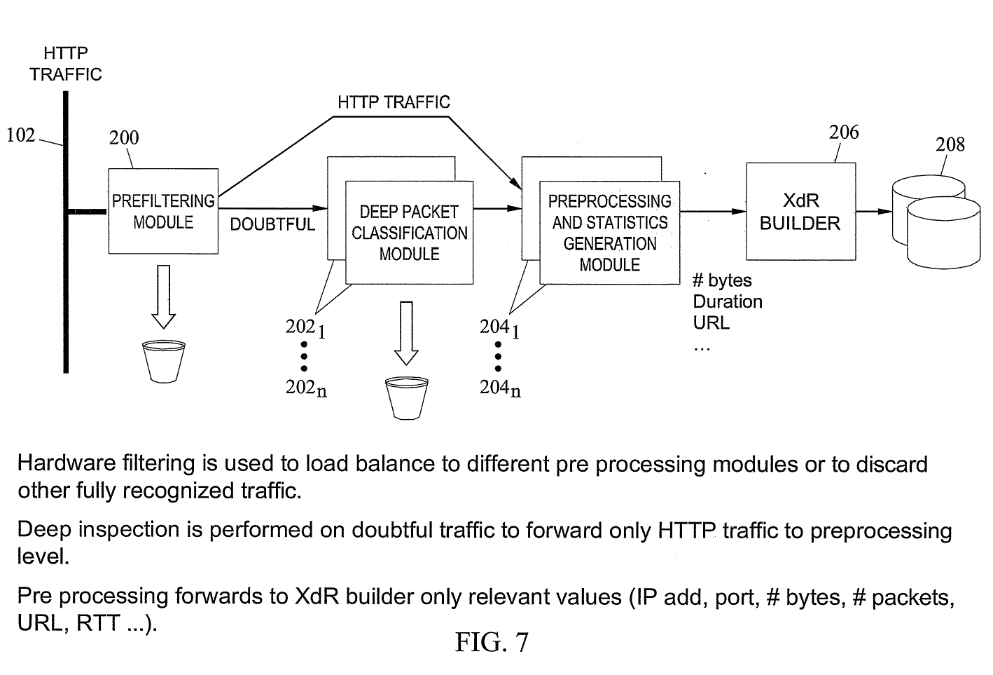

In yet another example of collecting data from multiple protocol traffic transmitted over a high bandwidth IP signaling link, HTTP traffic may be identified as requiring processing by preprocessing and statistics generation modules 204₁-204ₙ and relevant values may be forwarded to xDR generation module 206. FIG. 7 illustrates such an embodiment. In FIG. 7, packet classification module 200 identifies HTTP traffic and forwards it to preprocessing and statistics generation modules 204₁-204ₙ. Preprocessing and statistics generation modules 204₁-204ₙ extract relevant data from the HTTP traffic for generation of xDRs. For HTTP traffic, the relevant data may include the IP address, the port, the number of bytes, the number of packets, the URL, the roundtrip time, Internet search engine identity, Internet search engine search keywords, or other types of application data or non-application data. The extracted data may be forwarded to xDR generation module 206 without forwarding the HTTP packets. By performing this preprocessing at modules 204 and forwarding the results to xDR generation module 206, xDR generation module 206 can generate xDRs without having to decode the entire packets.

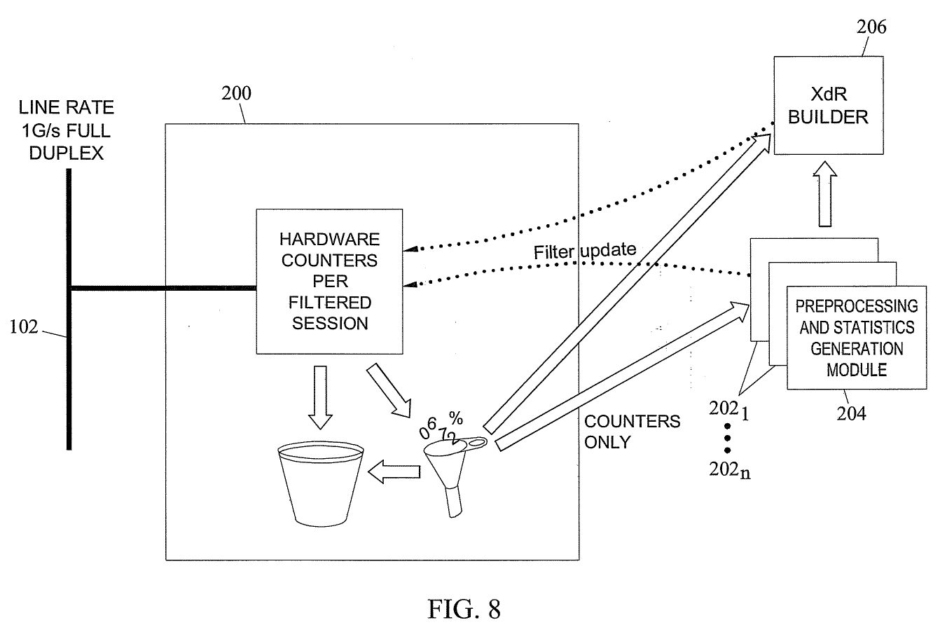

In yet another example, hardware filters implemented by preprocessing module 200 may be used to compute volume information, such as the number of packets or the number of bytes that traverse the link within a time period. FIG. 8 illustrates such an embodiment. In FIG. 8, preprocessing module 200 receives filter updates from modules 202, 204, and 206 for session based filtering. The filter updates may identify packets belonging to a particular session, for example by a source and destination IP addresses. For each session, prefiltering module 200 may generate a count and may then discard the packets for the session without the packet forwarding. The counts may be forwarded to modules 202, 204, or 206, depending on which data collection module requires packet counts.

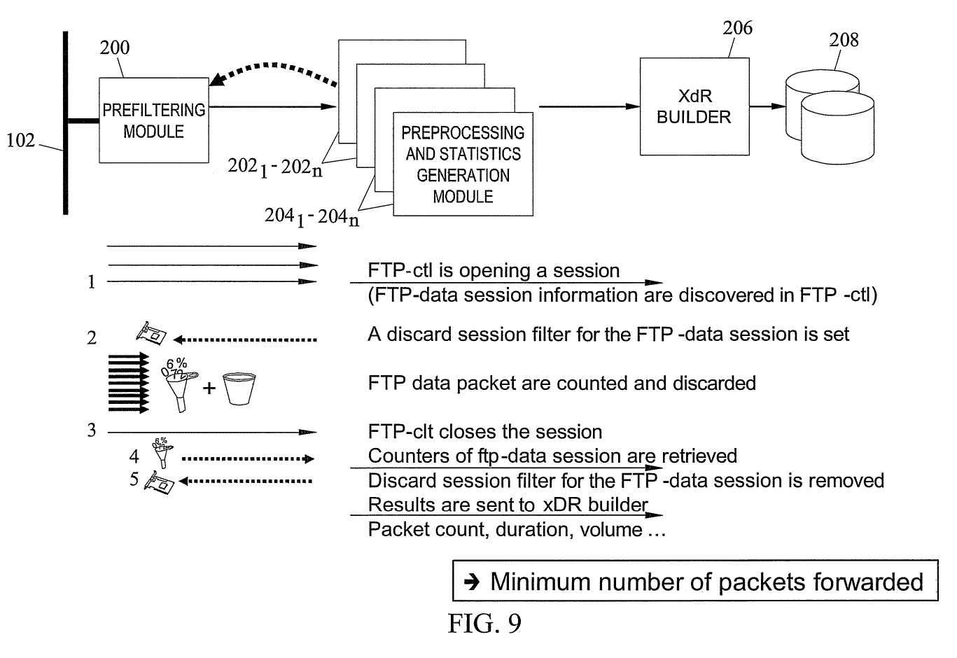

As another example of the type of information that may be generated by system 100, session counts may be generated for FTP traffic. FIG. 9 illustrates such an embodiment. In FIG. 9, prefiltering module 200 receives session-based filter criteria from modules 202₁-202ₙ and modules 204₁-204ₙ. In the first line of the message flow illustrated in FIG. 9, modules 204₁-204ₙ identify the opening of an FTP control session. Accordingly, modules 204₁-204ₙ set a discard filter in preprocessing module 200 to count packets in the FTP data session but to discard the packets. In line 3, modules 204₁-204ₙ detect closing of the FTP session. In line 4, preprocessing module 400 forwards the counters of the FTP data session to modules 204₁-204ₙ. In line 5, modules 204₁-204ₙ instruct preprocessing module 200 to discard the session filter and send the results to xDR builder 206. xDR builder 206 may then generate an xDR based on the FTP data session.

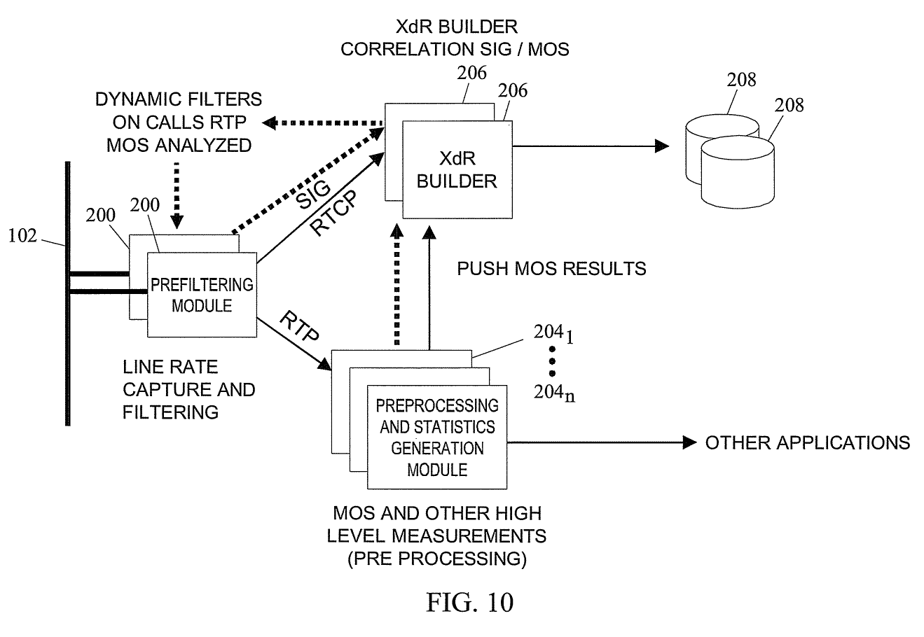

In yet another example, system 100 illustrated in FIG. 1 may be used to process signaling and bearer traffic for a voice over IP session. FIG. 10 illustrates such an embodiment. In FIG. 10, preprocessing module 200 receives network traffic copied from IP signaling link 102. Prefiltering module 200 identifies RTCP traffic and forwards that traffic to xDR builder 206. Preprocessing module 200 identifies RTP traffic and forwards that traffic to preprocessing and statistics generation modules 204₁-204ₙ. xDR builders 206 generate xDRs based on the RTCP traffic. Preprocessing and statistics generation modules 204₁-204ₙ calculate MOS values for the RTP traffic and push the MOS results to xDR builders 206 for incorporation in the xDRs. The resulting xDRs are stored in xDR storage 208.

As also illustrated in FIG. 10, the prefiltering performed by prefiltering module 200 may be dynamically updated based on data collection processing performed by xDR builders 206. For example, xDR builders 206 may generate session filters for identifying packets that are associated with the same session. Dynamically generated session filters may be used be prefiltering modules 200 to ensure that packets that are part of the same session are forwarded to the same data collection module.

According to another aspect of the subject matter described herein, if a packet attribute is identified at a deep packet classification module, a portion of the packet associated with the attribute may be removed, and the packet may be fed back into a previous stage for identification of another attribute of the $packet. For example, if deep packet classification module 2021 identifies that a is being tunneled inside of another packet type, deep packet classification module 202₁ may discard the tunneling packet and forward tunneled packet to prefiltering module for identification of the tunneled packet's protocol type.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A method for collecting data from network traffic traversing a high speed Internet protocol (IP) communication link, the method comprising:
cascading a plurality of packet classification filters to form n stages of the packet classification filters connected to series, n being an integer of at least two; and
at the nth stage, receiving network traffic copied from a high speed IP communication link and performing first packet classification processing to identify an attribute of each packet of the network traffic, and, if the attribute is identifiable at the nth stage and is of interest for a first type of data collection processing, performing the first type of data collection processing for the packet, and if the attribute is not identifiable at the nth stage, forwarding the packet to at least one additional stage of the n stages for second packet classification processing that is different from the first packet classification processing to identify the attribute.

2. The method of claim 1 wherein the second packet classification processing requires deeper inspection of each packet than the first packet classification processing.

3. The method of claim 1 wherein the IP communication link includes a telecommunications link carrying telecommunication signaling data, telecommunications bearer channel data, and data that is not telecommunication signaling or bearer channel data.

4. The method of claim 1 comprising discarding each packet at the nth stage for which the attribute is identifiable.

5. The method of claim 1 wherein the attribute comprises one of a protocol type and application data.

6. The method of claim 1 comprising, in response to identifying the attribute at the at least one additional stage, performing a second type of data collection processing for packets whose attribute is identified at the at least one additional stage and further comprising dynamically updating criteria used in the first packet classification processing based on results of one of the first and second types of data collection processing.

7. The method of claim 6 wherein dynamically updating criteria used in the first packet classification processing includes adding session aware filter criteria to be used in the first packet classification processing so that packets identified as part of the same session are forwarded to the same module for data collection processing.

8. The method of claim 1 wherein comprising truncating at least some of the packets at the nth stage and forwarding the truncated packets to the at least one additional stage for at least one of the second packet classification processing and a second type of data collection processing.

9. The method of claim 1 wherein the first type of data collection processing includes telecommunications detail record (xDR) generation and wherein the method further comprises performing a second type of data collection processing for at least some of the packets reaching the at least one additional stage, wherein the second type of data collection processing includes generation of a statistical measure based on the network traffic.

10. The method of claim 9 wherein the statistical measure comprises a call quality metric for a media connection.

11. The method of claim 10 wherein the call quality metric comprises a mean opinion score (MOS) value.

12. The method of claim 9 wherein the statistical measure includes percentages of traffic of different protocol types.

13. The method of claim 1 wherein the first type of data collection processing includes pre-processing of the packets for a second type of data collection processing performed for at least some of the packets reaching the at least one additional stage and wherein the method further comprises forwarding results of the pre-processing to the at least one additional stage.

14. The method of claim 1 comprising, in response to identifying the attribute at the at least one additional stage, removing a portion of the packet associated with the attribute and feeding the packet back into the nth stage for identification of another attribute of the packet.

15. A system for collecting data for network traffic traversing a high speed Internet protocol (IP) communication link, the system comprising:
at least one signaling link tap for copying network traffic from a high speed Internet protocol communication link;
a plurality of cascaded packet classification filters forming n stages of the packet classification filters connected in series, n being an integer of at least two, at least some of the stages including packet data collection modules for performing different types of packet data collection operations; and
wherein the packet classification filter at the nth stage receives network traffic copied form a high speed IP communication link and performs first packet classification processing to identify an attribute of each packet of the mixed protocol traffic, and, if the attribute is identifiable at the nth stage and is of interest for a first type of data collection processing, a first packet data collection module performs the first type of data collection processing for the packet, and, if the attribute is not identifiable at the nth stage, the packet classification filter at the nth stage forwards the packet to at least one additional stage of the n stages for second packet classification processing that is different from the first packet classification processing to identify the attribute.

16. The system of claim 15 wherein the second packet classification processing requires deeper inspection of each packet than the first packet classification processing.

17. The system of claim 15 wherein the packet classification filter at the nth stage is configured to discard each packet for which the attribute is identifiable.

18. The system of claim 15 wherein the attribute comprises at least one of a protocol type and application data.

19. The system of claim 18 wherein the packet classification filter at the at least one additional stage is adapted to send packets for which it identifies the protocol type back to the nth stage for identification of a protocol type of another portion of the packet.

20. The system of claim 15 wherein the packet classification filter of at least one of the n stages is adapted to dynamically update its packet classification filter criteria based on results of the data collection processing.

21. The system of claim 20 wherein dynamically updating the packet classification filter criteria includes adding a session aware filter criterion to the packet classification filter at the at least one stage so that packets identified as being part of the same session will be forwarded to the same packet data collection module.

22. The system of claim 15 wherein the packet classification filter at the nth stage is adapted to truncate at least some of the packets in the copied network traffic.

23. The system of claim 15 wherein the first packet data collection module comprises a telecommunications detail record (xDR) generation module for generating xDRs based on telecommunication signaling traffic and wherein the system further includes a second packet data collection module comprising a preprocessing and statistics generation module for generating a statistic based on telecommunications traffic.

24. The system of claim 23 wherein the preprocessing and statistics generation module is adapted to generate a call quality metric based on telecommunications bearer channel traffic.

25. The system of claim 24 wherein the call quality metric comprises a medium opinion score (MOS) value.

26. The system of claim 23 wherein the preprocessing and statistics generation module is adapted to identify a relative number of data packets of different protocols traversing the high speed IP communications link.

27. The system of claim 15 wherein the first type of data collection processing includes pre-processing of the packets for a second type of data collection processing and wherein the method further comprises forwarding results of the pre-processing from the first module to the second module.

28. A computer readable medium having stored thereon computer executable instructions that when executed by the processor of a computer perform steps comprising:
cascading a plurality of packet classification filters to form n stages of the packet classification filters connected in series, n being an integer of at least two; and
at the nth stage, receiving network traffic copied from a high speed IP communication link and performing first packet classification processing to identify an attribute of each packet of the network traffic, and, if the attribute is identifiable at the nth stage and is if interest for a first type of data collection processing, performing the first type of data collection processing for the packet, and if the attribute is not identifiable at the nth stage, forwarding the packet to at least one additional stage of the n stages for second packet classification processing that is different from the first packet classification processing to identify the attribute.
